(19) United States
(12) Patent Application Publication
(10) Pub. No.: US 2011/0090482 A1
(43) Pub. Date: Apr. 21, 2011

(54) OPTICAL POSITION DETECTING DEVICE AND METHOD THEREOF

(75) Inventors: CHENG-CHUNG SHIH, Fremont, CA (US); YUH-MIN LIN, San Ramon, CA (US)

(73) Assignee: CAPELLA MICROSYSTEMS, CORP., Road Town (VG)

(21) Appl. No.: 12/581,696

(22) Filed: Oct. 19, 2009

(51) Int. Cl. G01C 3/08; G01B 11/00

(52) U.S. Cl. 356/4.06; 356/614

(57) ABSTRACT

The present invention relates to an optical position detecting device and method thereof, comprising multiple light emitting components, a driving unit, at least one photo detecting unit, a position storing unit and a position determining unit. Each light emitting components disposed on a plane to form a sensing area respectively projects a light source into the sensing area. The disposing positions of light emitting components and photo detecting unit are recorded in the position determining unit. The driving unit drives light emitting components sequentially. When an object encounters the projected light source above the sensing area, thus sequentially creating a reflected light signal, the photo detecting unit respectively generates sensed signals based on the intensity of the reflected light signal. The position storing unit records the positions of light emitting components and photo detecting unit. The position determining unit determines the position of the object.

### BACKGROUND OF THE INVENTION

1. Field of the Invention

The present invention relates to an optical position detecting device and method thereof; in particular, the present invention relates to a photo position detecting device and method thereof capable of detecting three dimensional position and moving track.

2. Description of Related Art

At present, in operating numerous electronic apparatus with feedback controls, the optical sensing apparatus for displacement measurement and distance measurement plays an important role. The operation principal thereof essentially utilizes a light source for illumination, and in case the light source encounters a nearby object and reflects the emitted light source, the reflected light signal may be detected by a receiving device, so as to measure the property of the reflected light signal to concern the existence of the object.

Such a receiving device is usually composed of an array of photo diodes (PD) or phototransistors; for example. U.S. Pat. No. 4,865,443 (Howe et al.) discloses an optical displacement sensor which requires two sets of photo sensor arrays arranged in straight lines, and the distance between an object and the optical displacement may be effectively determined if the object is placed over one of the photo detecting arrays. U.S. Pat. No. 5,196,689 (Sugita et al.) discloses an object detecting device in which two or more photo receivers are disposed in order to determine the position of a target object.

Furthermore, U.S. Pat. No. 5,056,913 (Tanaka et al.) discloses an optical sensor using one photo sensing device, but it may only determine the straight line distance from an object to be detected to the photo sensing device.

Therefore, currently available photo sensors usually provide simply either distance or position determination function.

### SUMMARY OF THE INVENTION

In view of the aforementioned problems of the prior art, one objective of the present invention is to provide an optical position detecting device to determine the three dimensional position of an object.

According to another objective of the present invention is to provide an optical position detecting device to detect the three dimensional moving track of an object.

According to the aforementioned objectives, the present invention provides an optical position detecting device comprising a plurality of light emitting components, a driving unit, at least one photo detecting unit, a position storing unit and a position determining unit. The plurality of light emitting components are disposed on a plane to form a sensing area, and each light emitting components projects a light source into the sensing area respectively. The driving unit provides a time-division drive signal corresponding to each of the light emitting components to consistently drive each of the light emitting components. The photo detecting unit generates at least one sensed signal by sensing a reflected light signal generated by an object encountering the light source above the sensing area. The position storing unit records the disposing positions of each light emitting components and the disposing position of the photo detecting unit respectively. The position determining unit is connected to the driving unit, the photo detecting unit and the position storing unit, and determines the three dimensional position and moving track of the object above the sensing area based on the time-division drive signal and the sensed signal.

Wherein, the light emitting component may be a Light Emitting Diode (LED).

Wherein, the time-division drive signal is a periodical signal to drive each of the light emitting components sequentially.

Wherein, the object may be a finger, a paper or other materials capable of light reflection.

Wherein, the photo sensing unit comprises a photo sensor and a semicircle wide-angle lens, in which the photo sensor may be a phototransistor or a photo diode (PD), and the semicircle wide-angle lens may be disposed on the photo sensor to focus the reflected light signal on the photo sensor.

According to the aforementioned objectives of the present invention, a method of photo position detection is provided, comprising the following steps. Forms a sensing area by disposing a plurality of light emitting components on a plane, and each of the light emitting components respectively projects a light source into the sensing area. Generate a time-division drive signal by a driving unit in a time-division mode to drive each of the light emitting components to project light source into the sensing area by the light emitting components respectively. Generates at least one sensed signal with a strength information by the at least one photo detecting unit when a reflected light signal is sensed. Determine the position and distance from the plane above the sensing area by a position determining unit based on the time-division drive signal and the previously recorded disposing position of each light emitting component and the light detecting unit. Determines the three dimensional moving track of the object through the sensing signal of continuous time interval.

In summary, the optical position detecting device enabling three dimensional position and moving track detection features according to the present invention provides the following advantages.

The optical position detecting device is capable of determining a two dimensional and three dimensional positions of an object by the photo detecting unit, and further, in conjunction with the temporal information of each time-division signal, detecting a two dimensional and three dimensional moving track of the object.

### BRIEF DESCRIPTION OF THE DRAWINGS

FIG. 1 shows a block diagram of the optical position detecting device according to the present invention;

FIG. 2 shows a diagram for a first embodiment of the optical position detecting device according to the present invention;

FIG. 3 shows a diagram for the time-division drive signal and sensed signal in the first embodiment of the optical position detecting device;

FIG. 4 shows a diagram for the time-division drive signal and sensed signal in a second embodiment of the optical position detecting device;

FIG. 5 shows a diagram for the sensed signal corresponding to one single LED drive frequency in the second embodiment;

FIG. 6 shows a diagram for a third embodiment of the optical position detecting device according to the present invention;

FIG. 7 shows a diagram of the time-division drive signal as well as the sensed signal for move A and move B for the third embodiment of the optical position detecting device according to the present invention;

FIG. 8 shows a diagram of the time-division drive signal and the sensed signal intensity for the fourth embodiment of the optical position detecting device according to the present invention;

FIG. 9 shows a diagram for a fifth embodiment of the optical position detecting device according to the present invention;

FIG. 10 shows a diagram of the time-division drive signal and the sensed signal intensity for the fifth embodiment of the optical position detecting device according to the present invention;

FIG. 11 shows a stepwise flowchart for the method of optical position detection according to the present invention.

### DETAILED DESCRIPTION OF THE PREFERRED EMBODIMENTS

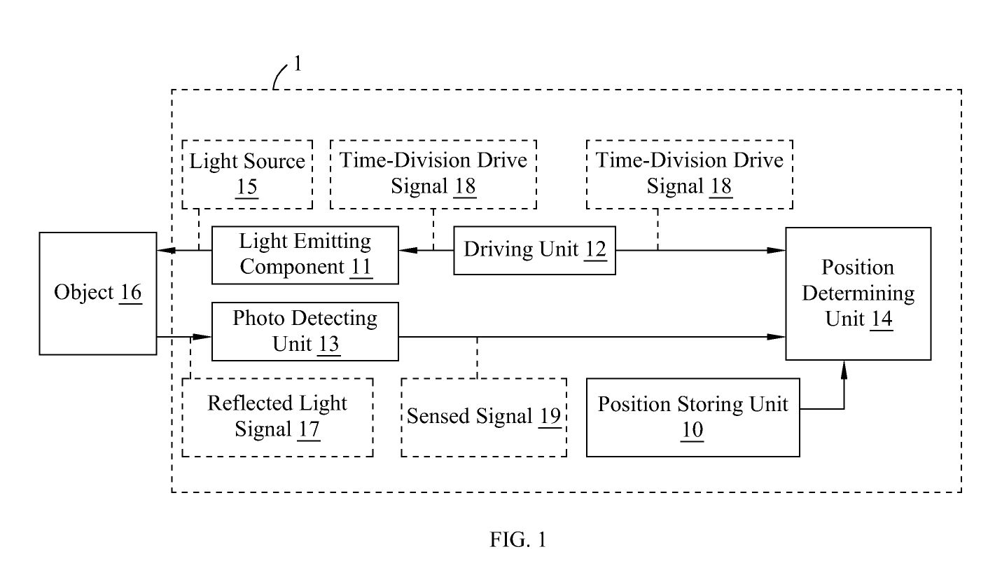

Refer to FIG. 1, a block diagram of the optical position detecting device according to the present invention is shown. In the Figure, the optical position 1 detecting device comprises a plurality of light emitting components 11, a driving unit 12, a photo detecting unit 13, a position storing unit 10 and position determining unit 14.

The plurality of light emitting components 11 are disposed in a prescribed fashion to form a sensing area 110, and a light source 15 is projected by each light emitting components 11 into the sensing area 110 respectively. The driving unit 12 is electrically connected to each of the plurality of light emitting components 11 to provide a time-division drive signal 18 to each of the plurality of emitting components 11 in a time-division mode. The time-division drive signal 18 may be a periodical signal allowing each light emitting components 11 to sequentially illuminate. When an object 16, e.g., a finger, paper or alternatively other materials capable of light reflection, encounters the light source 15 above the sensing area 110, the light source 15 may be blocked by the object 16 thereby generating the reflected light signal 17.

The photo detecting unit 13 is used to detect the reflected light signal 17 and converts the of the reflected light signal 17 into sensed signal 19, then the sensed signal 19 is transferred to the position determining unit 14.

The position storing unit 10 stores the disposing positions of each of the light emitting components 11 and the disposing position of the photo detecting unit 13.

The position determining unit 14 is electrically connected to the driving unit 12, the photo detecting unit 13 and the position storing unit 10 to receive the time-division drive signal 18 and the sensed signal 19 consistently. Since the disposing positions of each light emitting components 11 and the disposing position of the photo detecting unit 13 have been previously recorded in the position storing unit 10 and transferred to the position determining unit 14 through electrical connections, the two dimensional position of the object 16 located on the sensing area 110 and which LED is currently emitting light may be determined by the position determining unit 14 based on the time-division drive signal 18 and the sensed signal 19. Besides, the moving track of the object 18 on the plane may be determined by the position determining unit 14 in accordance with the sensed signal 19 within continuous time intervals and each corresponding time-division drive signal 18.

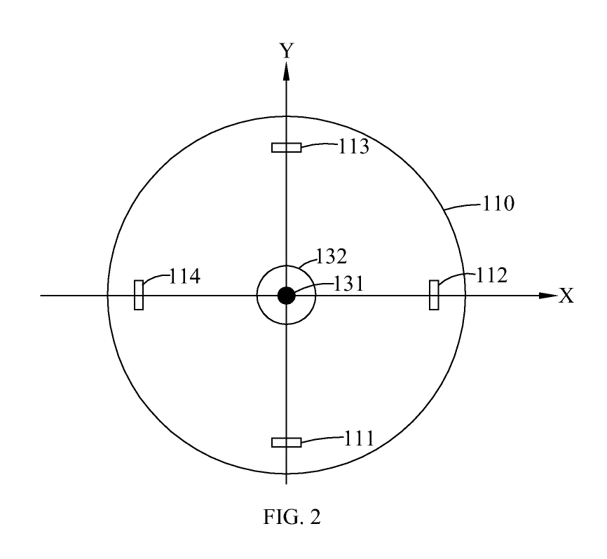

Refer to FIG. 2, wherein a diagram for a first embodiment of the optical position detecting device according to the present invention is shown. In the figure, the optical detecting device 1 comprises four light emitting components 11 and a photo detecting unit 13. The light emitting component may be an LED disposed on a plane so as to form a sensing area 110, where each light emitting components respectively indicates by LED1 111, LED2 112, LED3 113 and LED4 114. The photo detecting unit 13 comprises a photo sensor 131, in which the photo sensor 131 may be a phototransistor or a photo diode (PD), and a semicircle wide-angle lens 132 may be disposed on the photo sensor 131 to focus the reflected light signal 17 on the photo detecting unit 131 to effectively enlarge the sensing area 10.

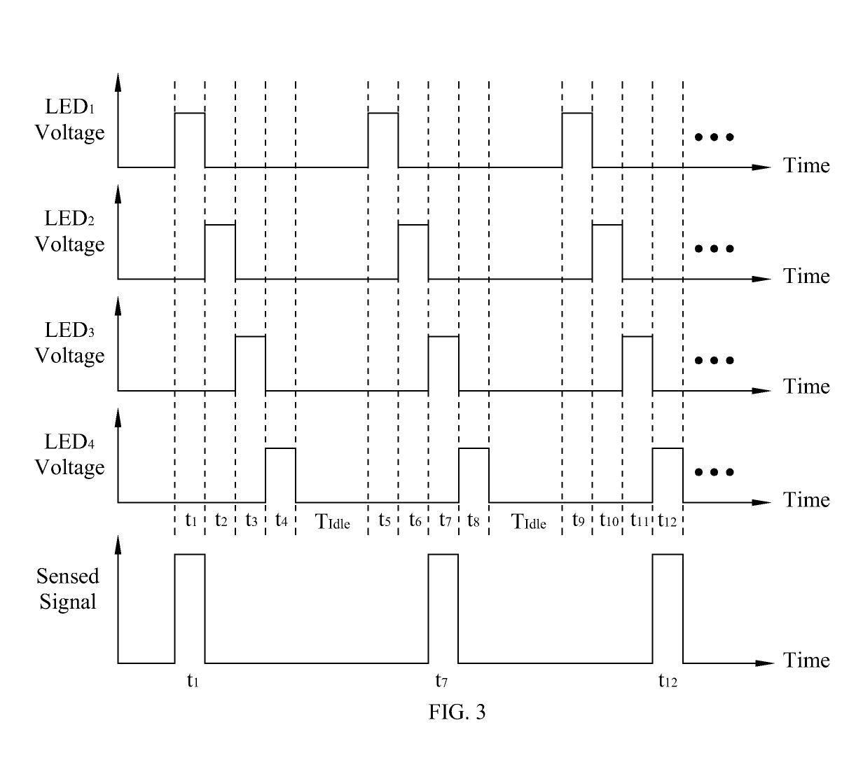

Refer subsequently to FIG. 3, wherein a diagram for the time-division drive signal and sensed signal in the first embodiment of the optical position detecting device is shown. Herein the horizontal axis indicates time, the vertical axis represents the voltage of the drive signal 19, and each time-division drive signal 18 may be a periodical signal sequentially driving each light emitting component 11. In the Figure, t1˜t12 indicate twelve time intervals. Each LED is sequentially driven during the four time intervals t1˜t4 to emit the light source 15 sequentially. After a tIdle time interval, the four LED are sequentially driven and the process repeats in such a pattern so as to consistently drive each LED. According to the sensed signal 19 illustrated in the present embodiment, in three time intervals t1, t7 and t12, three pluses are generated by the photo detecting unit 13, which represents the object 16 is above the LED1 111 in the time interval t1, above the LED3 113 in the time interval t7 and above the LED4 114 in the time interval t12. As such, it is possible to appreciate the two dimensional position of the object 16 above the sensing area 110 in each time interval. In conjunction with the time sequence relating to each time interval, it is possible to further identify that the two dimensional moving track of the object 16 traces from above the LED1 111 to above the LED3 113 then to above the LED4 114.

Taking the application of the present invention to a computer mouse as an example, if the sensed signal 19 of the a single light emitting component 11 is consistently received, indicating the mouse cursor continuously hovers above a corresponding light emitting component 11, then this may be treated as an operating command for a motion of scrolling a webpage in a specific direction. Alternatively, in case a signal indicating a motion from LED2 112 to LED3 113 then to LED4 114 or in an opposite direction is received, then this may represent that the mouse cursor moves from left to right or from right to left, which may be used as an operating command for turning up or down the playback volume of a audio/video playback hardware.

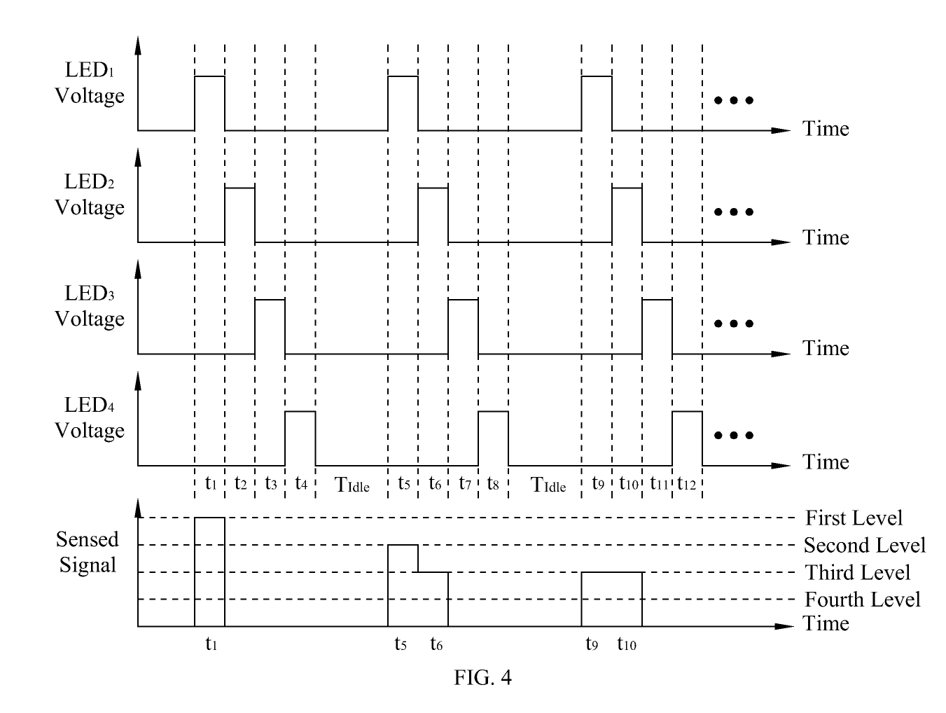

Refer now to FIG. 4, wherein a diagram for the time-division drive signal and sensed signal in a second embodiment of the optical position detecting device is shown. Compared with the sensed signal 19 of the first embodiment, the difference is in that the sensed signal 19 of the second embodiment includes the intensity information of the reflected light signal 17. The photo detecting unit 13 is allowed to generate a sensed signal 19 with multiple different levels in accordance with the intensity range of different reflected light signal 17, with four levels being illustratively generated in the present embodiment. Herein the stronger the intensity of the sensed signal becomes, the closer the object 16 to the corresponding light emitting component is; contrarily, the weaker the intensity of the sensed signal becomes, the farther the object 16 from the corresponding light emitting component is. In the Figure, during time intervals t1˜t4, t5˜t8 and t9˜t12, the photo detecting unit 13 generates five corresponding pulses, with the level of each pulse indicating the distance from the object to the corresponding LED. For example, the corresponding distance for the first level is 1 unit length, the corresponding distance for the second level is 2 unit lengths, the corresponding distance for the third level is 3 unit lengths and the corresponding distance for the fourth level is 4 unit lengths. The position determining unit 14 may determine that the length from the object 16 to the LED1 111 in time interval t1 is 1 unit, the length to the LED2 112 in time interval t5 are 2 units, the length to the LED2 112 in time interval t6 are 3 units, the length to the LED 1 111 in time interval t9 are 3 units and the length to the LED 1 111 in time interval t10 are 3 units based on the diagram for the sensed signal of second embodiment. Since during the time intervals t1˜t4 the sensed signal 19 is detected only in the time interval t1, the position of the object 16 during the time intervals t1˜t4 is located at 1 unit length above the LED1 111. The sensed signal is detected in both the time interval t5 and the time interval t6 during the time intervals t5˜t8. Thus during the time intervals t5˜t9 the object 16 is located at 2 unit lengths from the LED1 111 and 3 unit lengths from the LED1 112. The sensed signal is detected in both the time interval t9 and the time interval t10 during the time intervals t9˜t12. Thus during the time intervals t5˜t9 the object 16 is located at 3 unit lengths from the LED1 111 and 3 unit lengths from the LED2 112. Consequently, the three dimensional position of the object 16 over the sensing area 110 in each time interval may be determined by the position determining unit 14. Along with the time sequence relating to each time interval, it is possible to further determine that the three dimensional move track of the object 16 traces from 1 unit length above the LED 1 111 toward 2 unit lengths from the LED 1 111 and then 3 unit lengths from the LED2 112, subsequently toward 3 unit lengths from the LED1 111 and then 3 unit lengths from the LED2 112. The said unit length may be meter, centimeter or millimeter.

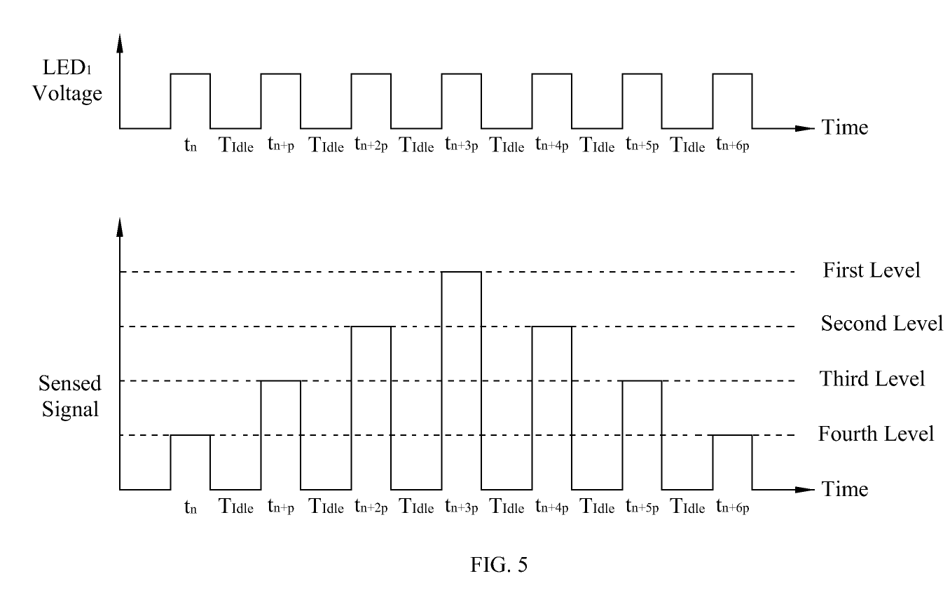

Take the application of the second embodiment on a computer mouse as an example, conjunctively referring to FIG. 5 wherein a diagram for the sensed signal corresponding to one single LED drive frequency in the second embodiment is shown. For example, the corresponding distance for the first level is 1 unit length, the corresponding distance for the second level is 2 unit lengths, the corresponding distance for the third level is 3 unit lengths and the corresponding distance for the fourth level is 4 unit lengths. In the Figure, the distribution from weak to strong and then from strong back to weak of the sensed signal level indicates that in time interval to the object 16 is located at 4 unit lengths above the LED1 111, in time interval tn+p located at 3 unit lengths above the LED1 111, while during time intervals from n+3p to n+6p the object 16 is located sequentially at 2, 1, 2, 3, 4 unit lengths above the LED1 111, i.e., an up-down-up motion, which may be used as an operating command for a single-click action on the mouse key. Alternatively, when levels in the sensed signal 19 present two continuous weak-strong-weak distributions, it indicates that the object, such as a finger, makes two continuous up-down-up motions over the LED1 111 which may interpreted as an operating command of a double-click action on the mouse key.

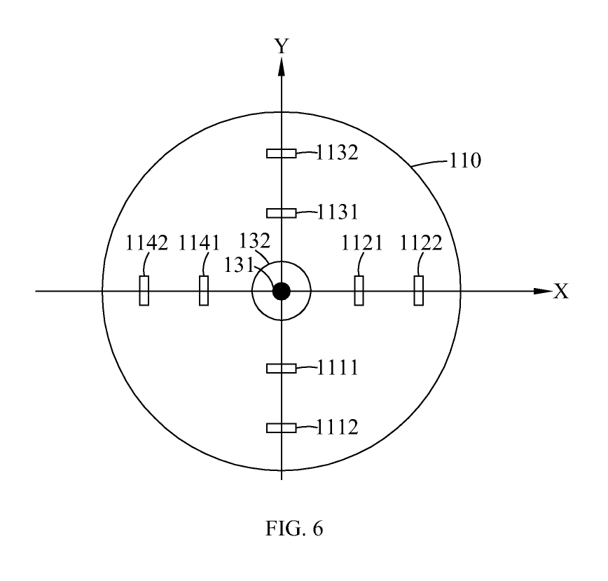

Refer to FIG. 6, wherein a diagram for a third embodiment of the optical position detecting device according to the present invention is shown. Compared with the first embodiment, the difference is in that the number of the light emitting components has been increased from four to eight which are individually driven by a corresponding time-division drive signal, with each LED indicated as LED11 1111˜LED42 1142. The rest portions of the present embodiment are identical to the counterparts in the first embodiment and descriptions thereof are herein omitted for brevity. Increase in numbers of LED and photo detecting units facilitates the photo detecting device of the third embodiment to demonstrate better resolution in photo position detection.

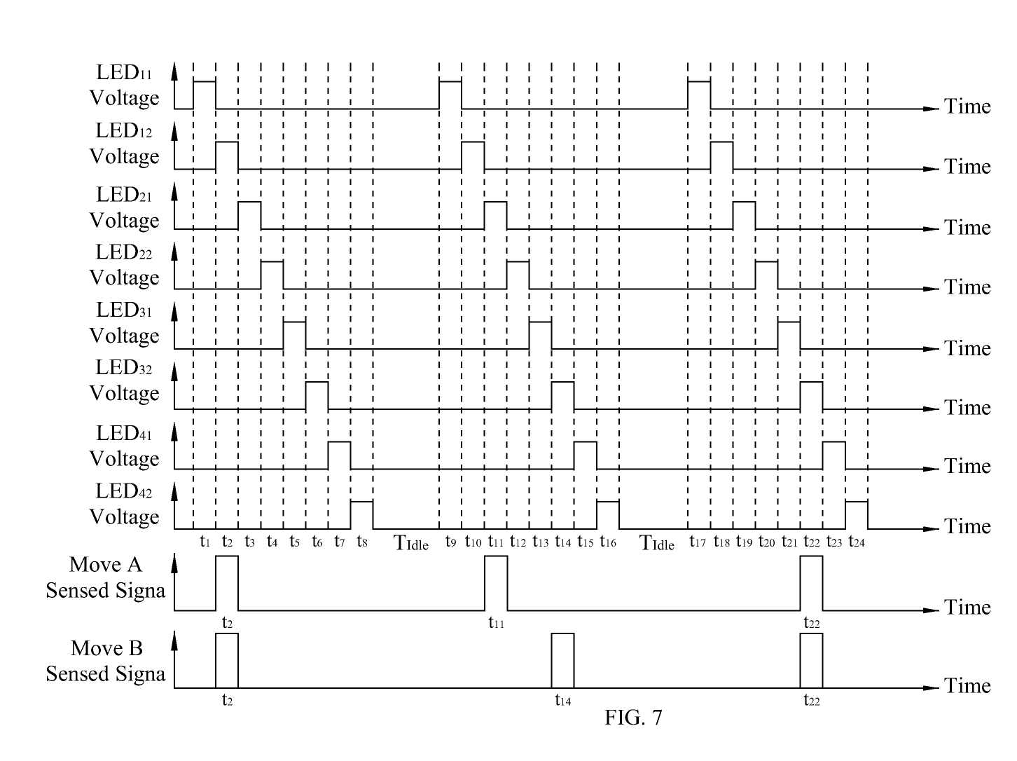

Refer now to FIG. 7, wherein a diagram of the time-division drive signal as well as the sensed signal for move A and move B for the third embodiment of the photo position detecting device according to the present invention is shown. In the Figure, t1˜t24 represent twenty four time intervals, and during the eight time intervals t1˜t8, each LED is sequentially driven such that each LED sequentially emits a light source 15, then after a time interval tIdle the eight LED are again sequentially driven, thus continuously driving each LED in such a pattern. The sensed signals for move A in time intervals t2, t11 and t22 cause the photo detecting unit 13 to generate three pulses, indicating that the object 16 is located over the LED12 1112 in time interval t2, over the LED21 1121 in time interval t11 and over the LED32 1132 in time interval t22. As such, the two dimensional position of the object over the sensing area in each time interval can be appreciated. Due to increase in number of LED's, finer variations in position may be determined. Also, in conjunction with time sequence relating to each time interval, it is possible to further identify that the two dimensional moving track of the object 16 traces from LED12 1112 to LED21 1121 then to LED32 1132. As for move B, the intensities of the sensed signal in time intervals t2, t14 and t22 cause the photo detecting unit 13 to generate three pulses, indicating that the object 16 is located over the LED12 1112 in time interval t2, over the LED14 1132 in time interval t11 then remaining unchanged afterward. Accordingly, it is possible to acquire the two dimensional position of the object on the sensing area in each time interval. Since the number of LED increases, finer variations in position may be determined Along with time sequence relating to each time interval, it is possible to further identify that the two dimensional move track of the object 16 traces from LED12 1112 to LED32 1132, and then remains unchanged.

By comparing the sensed signal for move A and move B, it can be seen that the difference is the move speed on the sensing area. The move B from above LED12 1112 to LED32 1132 is faster than the move A by eight time intervals.

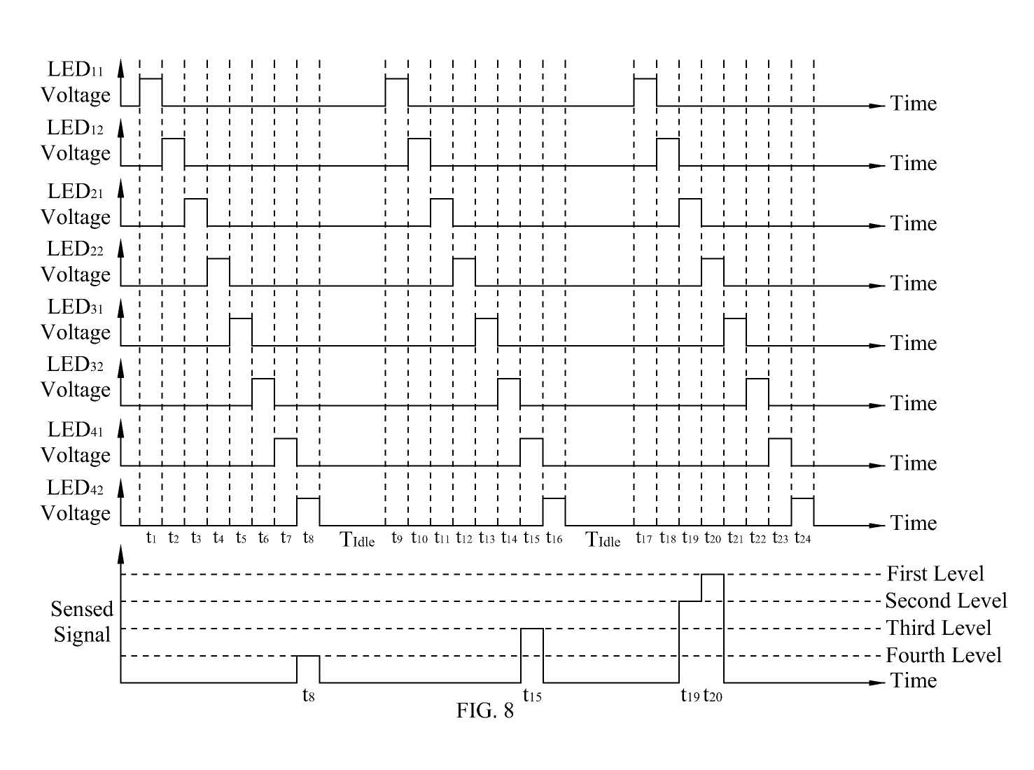

Refer to FIG. 8, wherein a diagram of the time-division drive signal and the sensed signal intensity for the fourth embodiment of the photo position detecting device according to the present invention is shown. Compared with the third embodiment, the difference is in that the sensed signal 19 in the present embodiment includes information about intensity of the reflected light signal 17; that is, the photo detecting unit 13 generates, based on the intensity range of different reflected light signal 17, the sensed signal 19 of multiple levels, and in the present embodiment four levels are exemplarily taken. The position determining unit 14 determines the altitude of the object 16 in accordance with the intensity level of the sensed signal 19. Herein the stronger the intensity of the sensed signal becomes, the closer the object to the corresponding light emitting component is; contrarily, the weaker the intensity of the sensed signal becomes, the farther the object from the corresponding light emitting component is. In the Figure, in time intervals t8, t15, t19 and t20, the photo detecting unit 13 generates four pulses of different levels, with each pulse level respectively reflecting the altitude of the corresponding LED. Taking the corresponding altitude for the first level is 1 unit length, the corresponding altitude for the second level is 2 unit lengths, the corresponding altitude for the third level is 3 unit lengths and the corresponding altitude for the fourth level is 4 unit lengths as an example, based on the diagram for the sensed signal of the fourth embodiment, the position determining unit 14 determines that the object 16 is located at 4 unit lengths above LED42 1142 in time interval t8, located at 3 unit lengths above LED41 1141 in time interval t15, located at 2 unit lengths above LED21 1121 in time interval t19 and 1 unit lengths above LED22 1122 in time interval t20. Consequently, it is possible to appreciate the position of the object 16 over the sensing area in each time interval, together with the time sequence relating to each time interval, it is possible to further identify that the two dimensional move track of the object 16 traces from 4 unit lengths above the LED421142 to 3 unit lengths above the LED41 1141 to 2 unit lengths above the LED21 1121 and then to 1 unit length above the LED22 1122. The said unit length may be meter, centimeter or millimeter.

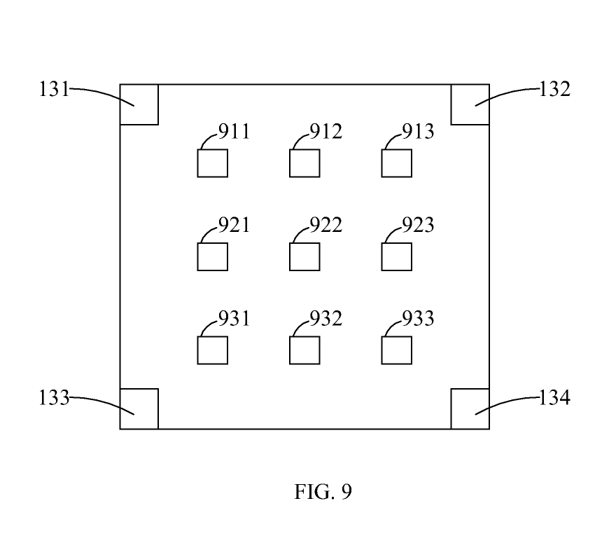

Refer next to FIG. 9, wherein a diagram for a fifth embodiment of the photo position detecting device according to the present invention is shown. Compared with the first embodiment the difference is in that the number of the light emitting components has been increased from four to nine which are individually driven by a corresponding time-division drive signal, with each LED indicated as LED911 911˜LED933 933; besides, the first photo detecting unit 1311, the second photo detecting unit 1312, the third photo detecting unit 1313 and the fourth photo detecting unit 1314 are individually installed at four corners. The rest portions of the present embodiment are identical to the counterparts in the first embodiment and descriptions thereof are herein omitted for brevity. Increase in number of light emitting components allows the photo detecting device in the fifth embodiment to demonstrate better resolution in photo position detection, while increase in number of photo detecting units 13 may facilitate effective enlargement of the sensing area 110.

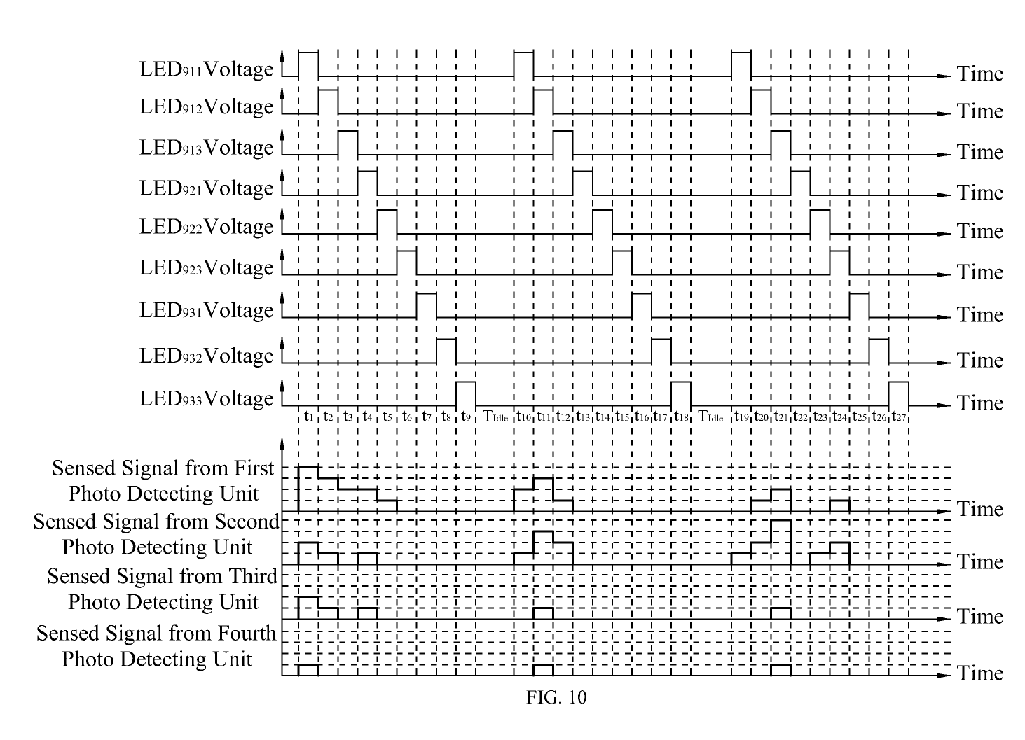

Refer next to FIG. 10, wherein a diagram of the time-division drive signal and the sensed signal intensity for the fifth embodiment of the photo position detecting device according to the present invention is shown. Compared with the third embodiment, the difference is in that there are four sensed signals 19 in the present embodiment and each sensed signal 19 includes the information about intensity of the reflected light signal 17; that is, the photo detecting unit 13 generates, based on the intensity range of different reflected light signal 17, the sensed signal 19 of multiple levels, and in the present embodiment four levels are exemplarily taken. The position determining unit 14 determines the altitude of the object 16 in accordance with the intensity level of the sensed signal 19, the disposing position of the photo detecting unit and the time-division drive signal. Herein the stronger the intensity of the sensed signal 19 becomes, the closer the object 16 to the corresponding light emitting component 11 is; contrarily, the weaker the intensity of the sensed signal 19 becomes, the farther the object 16 from the corresponding light emitting component 11 is. Hence, the position determining unit 10 can determine that the object 16 is located close to LED 911 911 in time intervals t1˜t9, close to LED 912912 in time intervals t10˜t18, and close to LED 913 913 while in time intervals t19˜t27.

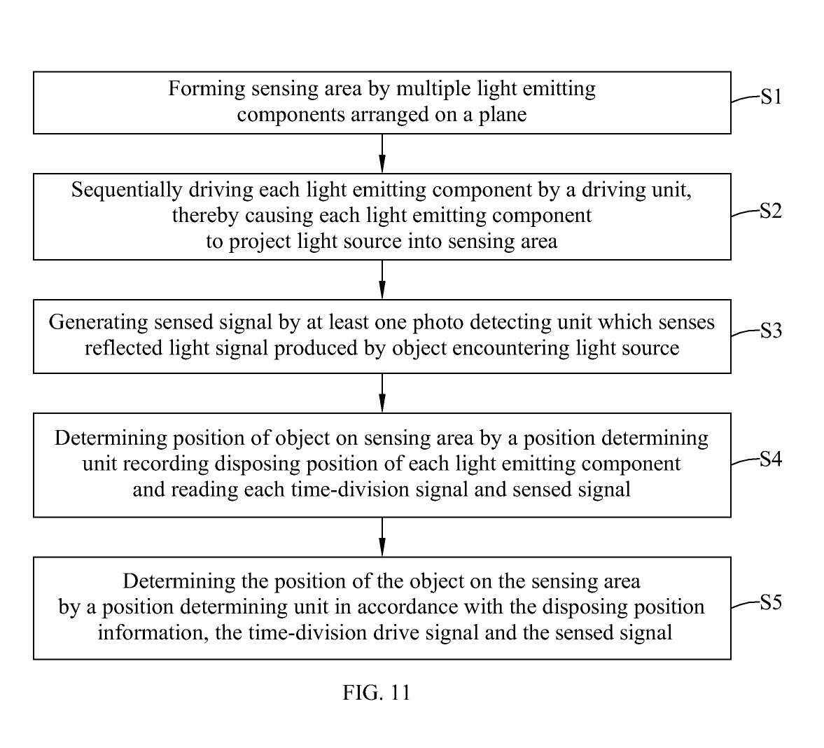

Refer finally to FIG. 11, wherein a stepwise flowchart for the method of photo position detection according to the present invention is shown. In the Figure, the said method of optical position detection comprises the following steps: in Step S1, forming a sensing area by means of a plurality of light emitting components arranged on a plane; in Step S2, sequentially driving each light emitting components by a driving unit thereby allowing each light emitting components to project a light source into the sensing area, in which the driving unit consistently provides a time-division drive signal to each light emitting components to cause each light emitting components to sequentially illuminate; in Step S3, generating a sensed signal by at least one photo detecting unit which senses the reflected light signal produced by an object encountering the light source, in which when the object encounters the light source on the sensing area, the light source reaches the surface of the object and is blocked, thus creating the reflected light signal from the surface of the object, and upon reception of the reflected light signal the photo detecting unit generates the sensed signal based on the intensity of the reflected light signal; in Step S4, respectively recording the disposing position of each light emitting component and disposing position of the photo detecting unit by using a position storing unit; in Step S5, determining the position of the object on the sensing area by a position determining unit in accordance with the disposing position information, the time-division drive signal and the sensed signal.

The aforementioned descriptions are merely exemplary, rather than being restrictive. All effectively equivalent modifications, alternations or changes made thereto without departing from the spirit and scope of the present invention are deemed to be encompassed within the range delineated by the claims set forth hereunder.

What is claimed is:

1. An optical position detecting device, comprising:
a plurality of light emitting components disposed on a plane to form a sensing area, and each of the plurality of light emitting components projecting a light source into the sensing area respectively;
a driving unit connected to the plurality of light emitting components generating a time-division drive signal in a time-division mode to drive each of the plurality of emitting components sequentially;
at least one photo detecting unit generating at least one sensed signal by sensing a reflected light signal generated by an object encountering the light source above the sensing area;
a position storing unit recording the disposing positions of the plurality of emitting components and the disposing position of the at least one photo detecting unit respectively; and
a position determining unit connected to the driving unit, the at least one photo detecting unit and the position storing unit, determining the position of the object above the sensing area based on the time-division drive signal and the at least one sensed signal.

2. The optical position detecting device according to claim 1, wherein the position determining unit further determines the vertical distance of the object from the plane based on the intensity of the reflected light signal.

3. The optical position detecting device according to claim 2, wherein the position determining unit further determines the moving track of the object based on the time-division drive signal and the plurality of corresponding sensed signals.

4. The optical position detecting device according to claim 3, wherein the moving track represents a continuous motion of the move parallel to the plane or the move vertical to the plane.

5. The optical position detecting device according to claim 1, wherein the time-division drive signal is a periodical signal.

6. The optical position detecting device according to claim 1, wherein the object is a finger, a paper or other materials capable of light reflection.

7. The optical position detecting device according to claim 1, wherein the at least one photo detecting unit comprises a photo sensor and a semicircle wide-angle lens, where the photo sensor is a phototransistor or a photo diode, and the semicircle wide-angle lens is disposed on the photo sensor to focus the reflected light signal on the photo sensor.

8. A method of optical position detection comprising the following steps:
forming a sensing area by disposing a plurality of light emitting components on a plane;
generating a time-division drive signal by a driving unit in a time-division mode to drive each of the plurality of light emitting components to project a light source into the sensing area by the plurality of light emitting components respectively;
generating at least one sensed signal by the at least one photo detecting unit sensing a reflected light signal generated by an object encountering the light source above the sensing area;
recording the disposing positions of the plurality of emitting components and the disposing position of the at least one photo detecting unit by a position storing unit respectively; and
determining the position of the object above the sensing area by a position determining unit based on the time-division drive signal, the sensed signal, the disposing positions of the plurality of light emitting components and the disposing position of the at least one photo detecting unit.

9. The method of optical position detection according to claim 8, wherein the position determining unit further determines the vertical distance of the object from the plane based on the intensity of the reflected light signal.

10. The method of optical position detection according to claim 9, wherein the position determining unit further determines the moving track of the object based on the time-division drive signal and the plurality of corresponding sensed signals.

11. The method of optical position detection according to claim 10, wherein the moving track represents a continuous motion of the move parallel to the plane or the move vertical to the plane.

12. The method of optical position detection according to claim 10, wherein the time-division drive signal is a periodical signal.

13. The method of optical position detection according to claim 8, wherein the object is a finger, a paper or other materials capable of light reflection.

14. The method of optical position detection according to claim 8, wherein the at least one photo detecting unit comprises a photo sensor and a semicircle wide-angle lens, where the photo sensor is a phototransistor or a photo diode, and the semicircle wide-angle lens is disposed on the photo sensor to focus the reflected light signal on the photo sensor.
